(19) United States
(12) Patent Application Publication
(10) Pub. No.: US 2009/0139249 A1
(43) Pub. Date: Jun. 4, 2009

(54) APPARATUS AND METHOD FOR MAINTAINING FRESHNESS OF FOODS

(75) Inventors: Kyungil CHO, Seoul (KR); Jaechan PARK, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/057,569

(22) Filed: Mar. 28, 2008

(30) Foreign Application Priority Data
Nov. 30, 2007 (KR) 10-2007-0123493

(51) Int. Cl. F24F 3/16; A47J 43/00; F25B 41/00; G05D 23/00

(52) U.S. Cl. 62/78; 99/485; 62/513; 700/300

(57) ABSTRACT

An apparatus for maintaining the freshness of foods is provided. The apparatus comprises first and second electrodes spaced oppositely to a predetermined distance, a voltage generator unit applying voltage between the first electrode and the second electrode, heat transfer means connected to the first electrode or the second electrode to absorb heat from the space between the first electrode and the second electrode, and a temperature control unit controlling the heat transfer means such that the space between the first electrode and the second electrode is of predetermined temperature, whereby the heat transfer means is connected to the electrode for voltage application, so that both the application of electric field and the temperature regulation are advantageously obtained using a single electrode without installing a separate device for temperature regulation.

### BACKGROUND OF THE INVENTION

1. Field of the Invention

The present invention relates to an apparatus and a method for maintaining the freshness of foods, and more particularly to an apparatus and a method for maintaining the freshness of foods, in which space where foods Ware positioned is regulated to a predetermined temperature using heat transfer means connected to electrodes, thereby maintaining the freshness of foods.

2. Description of the Prior Art

Foods storage devices such as a refrigerator need a technology for preserving foods for a long time while maintaining the freshness thereof. As an example of the technology, there is a method of lowering a temperature of foods through direct supply of cooled air to foods storage space. Also provided is another method in which a pipe having cooled air therein is put in foods storage space to regulate a temperature of foods indirectly, and a heater is used to regulate humidity of the space to thereby prevent foods from being dried.

Further, a recently available method is provided in which a thermoelectric module is operated so that a cooling plate thereof is cooled, and a heat pipe connected to the cooling plate is used to regulate a temperature of foods. Apart from the above and other methods using temperature regulation, there is also a method in which an electric field is applied to foods, making it possible to prevent the growth of microbes in the foods and oxidation of the foods and therefore maintaining the freshness of foods.

### SUMMARY OF THE INVENTION

The present invention has been made to solve the problems occurring in the prior art, and an object of the present invention is to provide an apparatus and a method for maintaining the freshness of foods by applying, to foods, a voltage for maintaining the freshness of foods using electrodes, and regulating a temperature of foods using heat transfer means connected to the electrodes, thereby implementing the voltage application and the temperature regulation at the same time.

In accordance with an aspect of the present invention, there is provided an apparatus for maintaining the freshness of foods comprising: first and second electrodes spaced oppositely to a predetermined distance; a voltage generator unit applying voltage between the first electrode and the second electrode; heat transfer means connected to the first electrode or the second electrode to absorb heat from the space between the first electrode and the second electrode; and a temperature control unit controlling the heat transfer means such that the space between the first electrode and the second electrode is of predetermined temperature.

In accordance with another aspect of the present invention, there is provided a method of maintaining the freshness of foods comprising the steps of: applying voltage, between a first electrode and a second electrode; and controlling heat transfer means connected to the first or second electrode such that the space between the first electrode and the second electrode is of predetermined temperature.

### BRIEF DESCRIPTION OF THE DRAWINGS

The above and other objects, features and advantages of the present invention will be more apparent from the following detailed description taken in conjunction with the accompanying drawings, in which:

FIG. 1 is a constructional diagram illustrating an exemplary embodiment of an apparatus for maintaining the freshness of foods according to the present invention;

FIG. 2 is a constructional diagram illustrating electrodes in an exemplary embodiment of an apparatus for maintaining the freshness of foods according to the the present invention;

FIG. 3 is an enlarged view illustrating the surface of the electrode in an exemplary embodiment of an apparatus for maintaining the freshness of foods according to the present invention;

FIG. 4 is a constructional diagram illustrating a temperature control unit in an exemplary embodiment of the apparatus for maintaining the freshness of foods according to the present invention;

FIG. 5 is a constructional diagram illustrating a temperature control unit in another exemplary embodiment of an apparatus for maintaining the freshness of foods according to the present invention; and

FIG. 6 is a flow chart illustrating a procedure of an exemplary embodiment, of a method of maintaining the freshness of foods according to present invention.

### DETAILED DESCRIPTION OF THE EXEMPLARY EMBODIMENTS

Hereinafter, exemplary embodiments of the present invention will be described with reference to the accompanying drawings.

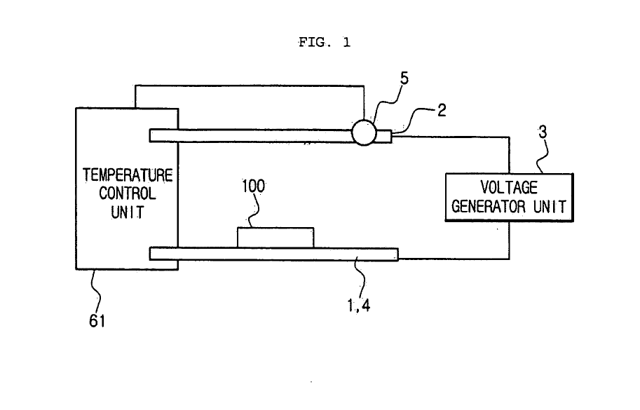

FIG. 1 is a constructional diagram illustrating an exemplary embodiment of an apparatus for maintaining the freshness of foods according to the present invention. As illustrated in FIG. 1, the apparatus includes a first electrode 1, a second electrode 2, a voltage generator unit 3, heat transfer means 4 connected to the first electrode 1, and a temperature control unit 6.

The first and second electrodes 1 and 2 are electrodes for applying voltage to foods 100, and the voltage generator unit 3 is a device for applying certain voltage between the first and second electrodes 1 and 2 for maintaining the freshness of foods. The voltage applied may be direct current voltage, alternating current voltage with certain frequency, or combined voltage of direct current voltage and alternating current voltage. The foods 100 are positioned between the first electrode 1 and the second electrode 2, and receive therein the electric charges by the voltage applied between the electrodes so as to prevent the oxidation and the growth of microbes in the foods 100.

Apart from using voltage for maintaining the freshness of foods, the heat transfer means 4 is connected to one or two of the first electrode 1 and the second electrode 2 to thereby regulate the temperature of the space where the foods 100 are positioned. Although the embodiments of the present invention have described that the heat transfer means 4 is connected to the first electrode 1, the heat transfer means 4 may be connected to the second electrode 2 or both the electrodes 1 and 2.

Further, in an embodiment of the present invention, the heat transfer means 4 may be integrated with the first electrode 1 or the second electrode 2 through the insertion thereinto. The heat transfer means 4 absorbs heat from the space between the first electrode 1 and the second electrode 2 to thereby regulate the temperature between the two electrodes 1 and 2 to a predetermined temperature.

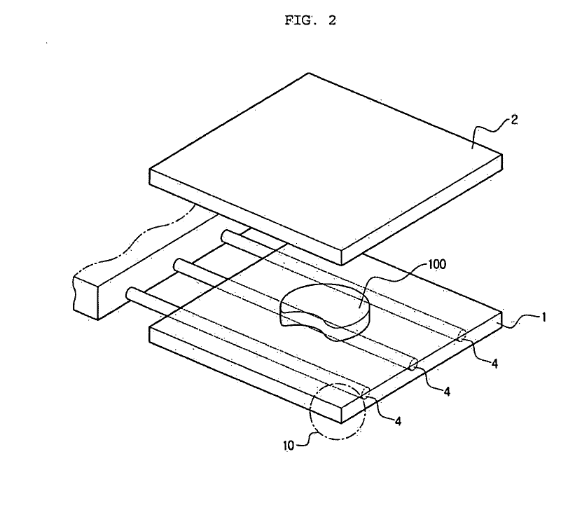

FIG. 2 is a constructional diagram illustrating the first and second electrodes 1 and 2 and the heat transfer means 4 in an exemplary embodiment of an apparatus for maintaining the freshness of foods according to the present invention. Referring to FIG. 2, the first and second electrodes 1 and 2 are positioned oppositely and spaced to a predetermined distance. Although the first and second electrodes 1 and 2 are arranged vertically as illustrated in FIGS. 1 and 2, they may be arranged horizontally or at a different angle according to other embodiment. Voltage is applied between the first electrode 1 and the second electrode 2 by the voltage generator unit 3 so that the freshness of foods 100 can be maintained by the voltage applied.

Meanwhile, the heat transfer means 4 for absorbing heat from the space between the first and second electrodes 1 and 2 is integrated with the first electrode 1 through the insertion thereinto. The heat transfer means 4 absorbs heat from the surface of the first electrode 1 to thereby regulate the temperature of the space where foods are positioned.

Although the embodiment of FIG. 2 has illustrated that three pipes are inserted into and integrated with the first electrode 1 as the heat transfer means 4, the number and the shape of the heat transfer means 4 may be constructed differently according to embodiments. Like this, the first electrode 1 and the heat transfer means 4 are used to be connected with each other, so that there is an advantage in that without having a need to install a separate cooling device, an electrode for applying an electric field can also be used as cooling means.

In an embodiment, the heat transfer means 4 may comprise one or more heat pipes. The heat pipe is heat transfer means that transfers heat flowing upon condensation and evaporation of a coolant circulating through a pipe, thereby efficiently regulating the temperature of the space where foods are positioned. Further, in another embodiment, the heat transfer means 4 may be composed of an air pipe, into which a coolant such as cooled gas is injected, or others.

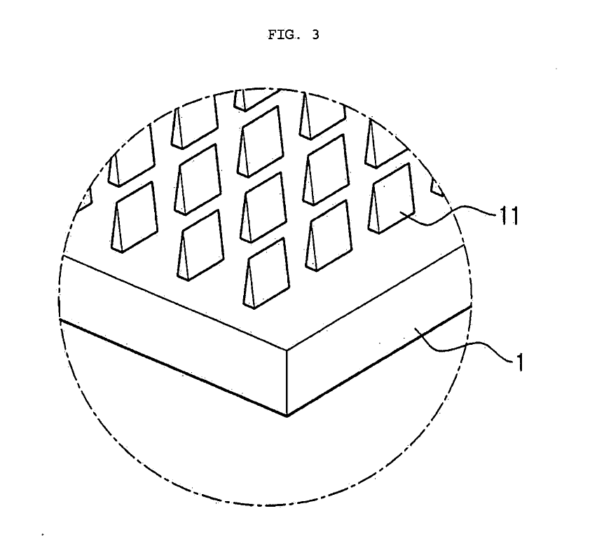

Further, in an embodiment, the first electrode 1 may be provided, on its surfaces with a plurality of projections to improve heat transfer efficiency by the first electrode 1, which will be described with reference to FIG. 3.

FIG. 3 is an enlarged view illustrating the surface of the first electrode 1 shown in FIG. 2. In the embodiment of FIG. 3, a plurality of projections 11 is formed on the surface of the first electrode 1 connected with the heat transfer means 4. When the plurality of projections 11 is formed on the electrode, the surface area of the first electrode 1 is increased so that heat transfer efficiency through the first electrode 1 and the heat transfer means 4 is advantageously improved. Further, this ensures efficient application of voltage to foods.

In the embodiment of FIG. 3, the projection 11 is of a rectangular planar structure protruding upward from the first electrode 1. However, the shape and the number of the projections may be changed according to embodiments, which is covered within a scope of the present invention.

Referring to FIG. 1, a temperature control unit 6 is connected to the heat transfer means 4 to control the heat transfer means 4 such that the space between the first electrode 1 and the second electrode 2 is of predetermined temperature. In an embodiment, the temperature of the space between the first and second electrodes 1 and 2 is measured by using a temperature sensor 5, and the temperature measured is transmitted to the temperature control unit 6.

The temperature control unit 6 controls the heat exchange of the heat transfer means 4 according to the measured temperature from the temperature sensor 5 to thereby regulate the space between the first and second electrodes 1 and 2 to have predetermined temperature. For 1 instance, if the temperature of the space is low, control is carried out so as to increase the temperature of the heat transfer means 4, and if the temperature is high, control is done so as to lower the temperature of the heat transfer means 4, thereby regulating the space between the electrodes to have predetermined temperatures.

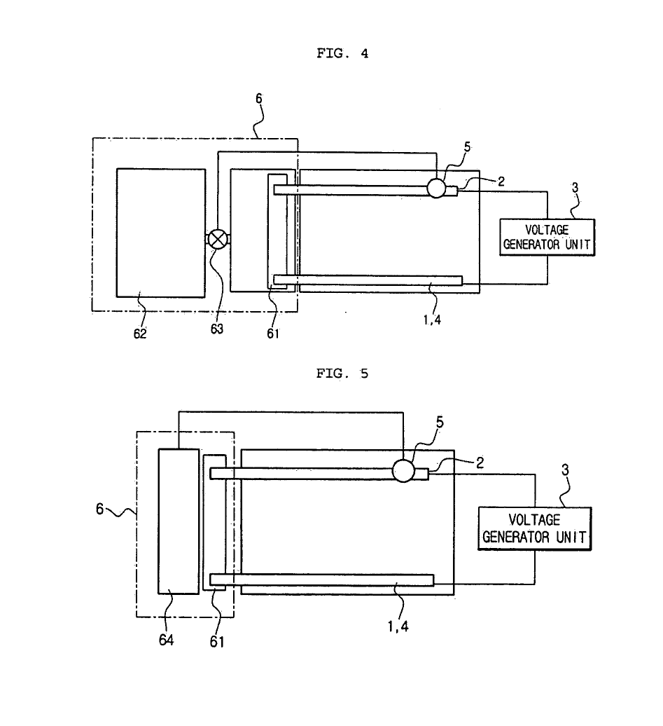

The temperature control unit 6 may be constructed to have diverse types of devices for discharging heat absorbed by the heat transfer means 4. FIG. 4 is a constructional diagram illustrating a temperature control unit performing heat exchange of heat transfer means using a coolant supplied by a cooler according to an embodiment of the present invention. Referring to FIG. 4, the temperature control unit includes a cooling plate 61 connected to the heat transfer means 4, a cooler 62 supplying a coolant having predetermined temperature, and a coolant regulator 63, regulating the amount of the coolant supplied from the cooler 62 to the heat transfer means 4.

FIG. 4 illustrates an embodiment where the heat transfer means 4 is a heat pipe. Herein, in order for efficient heat exchange by the heat pipe, the heat transfer means 4 is connected to the cooling plate 61. The cooling plate 61 is composed of a metal plate with high thermal conductivity, and is maintained at low temperature by the coolant discharged from the cooler 62 to allow heat absorbed by the heat transfer means 4 to be discharged. However, in case where the heat transfer means 4 is an air pipe according to other embodiments of the present invention, it is possible that the heat transfer means 4 is directly connected to the coolant regulator 63 without the cooling plate 61 to thereby supply a coolant in the heat transfer means 4.

The cooler 62 cools a coolant, such as gas, to predetermined temperature and stores it. The cooler supplies the coolant to the heat transfer means 4 according to the regulation of the coolant regulator 63. The coolant regulator 63 regulates the amount of the coolant supplied from the cooler 62 according to the temperature of the space between the first and second electrodes 1 and 2, which is measured by the temperature sensor 5. For instance, the temperature can be regulated such that if the temperature of the space between the electrodes 1 and 2 is not less than the predetermined temperature, the coolant is supplied from the cooler 62, and if the temperature is not more than the predetermined temperature, the supply of coolant is blocked. Heat absorbed by the heat transfer means 4 is discharged by the coolant supplied from the cooler 62.

FIG. 5 is a constructional diagram illustrating a temperature control unit performing the heat exchange of heat transfer means using a thermoelectric module according to another embodiment of the present invention. Referring to FIG. 5, the temperature control unit 6 includes a thermoelectric module 64 and a cooling plate 61. As described before, the cooling plate 61 is a device for efficient heat exchange of the heat transfer means 4. The thermoelectric module 64 is a device for upon application of electric current, generating a temperature difference between both surfaces of the module due to thermoelectric effect. The thermoelectric module 64 creates low temperature in the cooling plate to thereby allow heat to be discharged from the heat transfer means 4.

The temperature control unit 6 controls the process of discharging heat of the heat transfer means 4 absorbed from the space between the first and second electrodes 1 and 2, and it is accordingly possible to regulate the space where foods are positioned to have predetermined temperature.

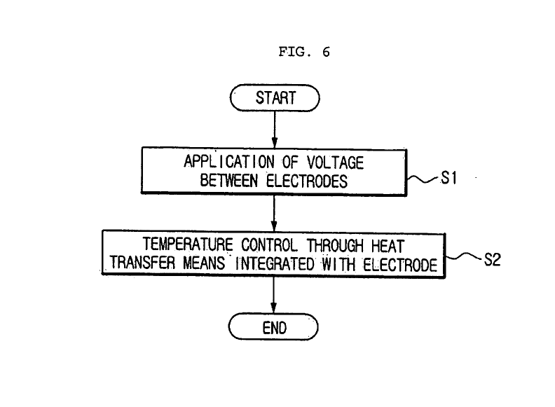

FIG. 6 is a flow chart illustrating a procedure of an exemplary embodiment of a method of maintaining the freshness of foods according to the present invention. Referring to FIG. 6, the method starts with the step S1 wherein the voltage generator unit 3 applies voltage between the first and second electrodes 1 and 2. The voltage applied may be direct current voltage, alternating current voltage with certain frequency, or combined voltage of the direct current voltage and the alternating current voltage.

Next, the temperature control unit 6 controls the heat transfer means 4 to regulate the space between the first and second electrodes 1 and 2 to have predetermined temperature (S2). The control of the heat transfer means 4 by the temperature control unit 6 may be carried out in such a way that according to the embodiments, the coolant is supplied to the heat transfer means 4, or otherwise the temperature of heat transfer means 4 is lowered using the thermoelectric module.

Depending upon the control of the temperature control unit 6, the heat transfer means 4 connected to the first electrode 1 or the second electrode 2 absorbs heat from the space between the electrodes. Further, in an embodiment, the heat transfer means 4 may be integrated with the electrode through the insertion thereinto, so that it is made into one electrode with the first or second electrode 1 or 2.

According to the apparatus and a method for maintaining the freshness of foods according to the embodiments of the present invention, the heat transfer means is connected to the electrode for voltage application, so that both the application of electric field and the temperature regulation are advantageously obtained using a single electrode without installing a separate device for temperature regulation. Further, the plurality of projections is formed on the electrode, so that the efficiencies of heat transfer and voltage application by the electrode are advantageously improved.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An apparatus for maintaining the freshness of foods comprising:
first and second electrodes spaced oppositely to a predetermined distance;
a voltage generator unit applying voltage between the first electrode and the second electrode;
heat transfer means connected to the first electrode or the second electrode to absorb heat from the space between the first electrode and the second electrode; and
a temperature control unit controlling the heat transfer means such that the space between the first electrode and the second electrode is of predetermined temperature.

2. The apparatus for maintaining the freshness of foods according to claim 1, wherein the temperature control unit comprises:
a cooler storing a coolant having predetermined temperature; and
a coolant regulator regulating the amount of the: coolant supplied from the cooler to the heat transfer means.

3. The apparatus for maintaining the freshness of foods according to claim 1, wherein the temperature control unit comprises a thermoelectric module regulating the temperature of the heat transfer means.

4. The apparatus for maintaining the freshness of foods according to claim 1, wherein the heat transfer means comprises one or more heat pipe or one or more air pipe.

5. The apparatus for maintaining the freshness of foods according to claim 1, wherein the first electrode or the second electrode comprises a plurality of projections formed on the surface of the electrode.

6. The apparatus for maintaining the freshness of foods according to claim 1, wherein the heat transfer means is integrated with the first electrode or the second electrode.

7. A method of maintaining the freshness of foods comprising the steps of:
applying voltage between a first electrode and a second electrode; and
controlling heat transfer means connected to the first or second electrode such that the space between the first electrode and the second electrode is of predetermined temperature.

8. The method of maintaining the freshness of foods according to claim 7, wherein the step of controlling the heat transfer means comprises the step of supplying a coolant with predetermined temperature to the heat transfer means.

9. The method of maintaining the freshness of foods according to claim 7, wherein the step of controlling the heat transfer means comprises the step of regulating the temperature of the heat transfer means using a thermoelectric module.

10. The method of maintaining the freshness of foods according to claim 7, wherein the, heat transfer means includes one or more heat pipe or one or more air pipe.

11. The method of maintaining the freshness of foods according to claim 7, wherein the heat transfer means is integrated with the first electrode or the second electrode.
